(19) United States
(12) Patent Application Publication
(10) Pub. No.: US 2026/0115721 A1
(43) Pub. Date: Apr. 30, 2026

(54) MICROFLUIDIC DEVICE AND METHOD FOR PROVIDING A FLUID IN A HYDRODYNAMIC FLOW CONFINEMENT

(71) Applicant: Max-Planck-Gesellschaft zur Förderung der Wissenschaften e.V., München (DE)

(72) Inventors: Vahid Sandoghdar, Erlangen (DE); Cornelia Holler, Erlangen (DE); Richard William Taylor, Erlangen (DE)

(73) Assignee: Max-Planck-Gesellschaft zur Förderung der Wissenschaften e.V., München (DE)

(21) Appl. No.: 19/365,250

(22) Filed: Oct. 22, 2025

(30) Foreign Application Priority Data
Oct. 25, 2024 (EP) 24208957.1

(51) Int. Cl. B01L 3/00

(52) U.S. Cl. CPC B01L 3/502746; B01L 2200/027; B01L 2200/16; B01L 2300/0858; B01L 2300/0867; B01L 2400/0463; B01L 2400/082; B01L 2400/084

(57) ABSTRACT

Provided is a microfluidic device with a front end comprising a tip with an opening for providing a hydrodynamic flow confinement. The device includes a first inflow channel adapted to provide a microfluidic flow to the tip, an outflow channel adapted to collect at least partially the microfluidic flow provided via the first inflow channel at the tip, and a second inflow channel adapted to provide a microfluidic flow to the tip. The device is characterized in that at the front end the first inflow channel extends within the outflow channel and the outflow channel extends within the second inflow channel.

### CROSS REFERENCE TO RELATED APPLICATIONS

This application claims priority to European patent application EP 24 208 957.1 filed on Oct. 25, 2024, which is hereby incorporated by reference in its entirety.

### TECHNICAL FIELD

Provided is a microfluidic device having a front end comprising a tip with an opening for providing a hydrodynamic flow confinement. The disclosure is related to microfluidic pipettes.

### BACKGROUND

The delivery of chemical reagents to cells is a fundamental action in life science research. Delivery with spatial and temporal precision is also important in other fields of science and technology where chemical or biochemical processes can be initiated or controlled in a complex medium. Conventional practice is to introduce chemical reagents to the cellular milieu, with no specificity or control over where and when material communicates with the external face of the cell, or exact control on the quantity of material that is presented. This approach is often adequate for investigations addressing large ensembles of cells, where statistical averages of relevant parameters suffice.

In life science research where investigations are directed towards elucidating the behavior and contributions of individual cells within ensembles (i.e. cultures or tissues) and of intracellular processes often incorporating optical microscopy, the former approach may be unsuitable.

There is a need to steer the delivery of reagents to the surfaces and immediate extra-cellular space of individual cells in a way that delivery is exclusive, that is, the chemical reagents communicate only with select individual cells.

Furthermore, there is a need to restrict delivery of the experimental reagents to a length-scale comparable to, and smaller than, the physical footprint of the target cell.

In addition, there is a need to perform the above delivery within biological fluidic media that may present adverse conditions for device operation, i.e. presence of contaminant materials or otherwise that may degrade device operation, and thus there is a need to steer environmental media in the local vicinity of the microfluidic device.

Applications that require microscale steering of reagent delivery frequently occur for reagents dissolved in a solvent (often principally water) where the target substrate, such as a cell, is also within a fluidic environment (also often principally water). To achieve steerable delivery of one fluidic solution within an open fluidic environment, the phenomenon of Hydrodynamic Flow Confinement (HFC) is used.

Hydrodynamic flow confinement may describe a phenomenon wherein a jet of laminar fluid, whilst propagating within an encompassing fluid medium, remains contained within a consistent and spatially well-defined envelope. Hydrodynamic flow confinement (HFC) of a reagent may occur in a fluid when the rate of the reagents advective transport (i.e. flow) is greater than its rate of diffusive transport. The following documents may provide information on HFC:
Delamarche, E and Kaigala, G V, “Open-Space Microfluidics: Concepts, Implementations, Applications”, Weinheim: Wiley-VCH Verlag GmbH & Co. KGaA (2018)

In such a fluid, when the fluid velocity is sufficiently large and the free path length sufficiently short, transport may be governed by the advective flow envelope, and the contributions of diffusion may be neglected. This may mean that the jet and the medium fluids do not mix nor is there an exchange of materials.

An advective flow envelope can be created, for example, by jetting or injecting a fluid at high positive pressure (P₊) out of the aperture of a guiding channel into an open fluidic environment. A more useful, spatially confined envelope may be brought about by introducing a second aperture acting simultaneously to aspire fluid out of the open fluidic volume by using negative pressure (P₋), where when compared in absolute values: P₋>P₊.

The jet of fluid may thus flow out of the first aperture and into the second, all whilst never leaving the advective envelope of fast fluid flow. Positioning both apertures closer together leads to the strongest, hence smallest, envelopes of confinement.

Arranging the apertures such that one aperture lies full within the extent of the other results in efficient confinement and optimal envelope generation. Provided an ‘injection’ and ‘aspiration’ aperture, hydrodynamically confined flow may be realized through various channel and aperture geometries. Exchange of materials between the steered jet of fluid and the surface of the target object may occur through intersection of the fluid jet with the target object's surface.

The apertures of microfluidic devices that operate under strong fluidic aspiration are also prone to blocking or clogging in the event of the aspiration of matter present in the surrounding fluid, for example remnants of dead cells or other cell debris. Steering the surrounding fluid, for example via a fluidic jet, in a direction—perhaps away from—the apertures of the microfluidic device, ameliorates this issue.

The document U.S. Pat. No. 9,658,240 B2 describes microfluidic pipette with integrated wells for solution storage.

### SUMMARY

Provided is a microfluidic device having a front end comprising a tip with an opening for providing a hydrodynamic flow confinement. The microfluidic device comprises a first inflow channel adapted to provide a microfluidic flow to the tip and an outflow channel adapted to collect at least partially the microfluidic flow provided via the first inflow channel at the tip. The device also includes a second inflow channel adapted to provide a microfluidic flow to the tip. At the front end, the first inflow channel extends within the outflow channel and the outflow channel extends within the second inflow channel.

Furthermore, a method for providing a fluid in a hydrodynamic flow confinement is provided. The method comprises providing a microfluidic device having a front end comprising a tip with an opening for providing the sheathed hydrodynamic flow confinement, wherein at the front end a first inflow channel extends within an outflow channel and the outflow channel extends within a second inflow channel. The method further comprises providing a microfluidic flow of the fluid to the tip via the first inflow channels of the microfluidic device. The method further comprises at least partially collecting the microfluidic flow of the fluid provided via the first inflow channel and the second inflow channel at the tip by the outflow channel of the microfluidic device.

### BRIEF DESCRIPTION OF THE DRAWINGS

In the drawings:

FIG. 1A shows a schematic illustration of a microfluidic device according to an optional embodiment,

FIG. 1B shows a microfluidic device according to an optional embodiment in a perspective view,

FIG. 2A shows an enlarged view of a tip of a microfluidic device according to an optional embodiment,

FIG. 2B shows an enlarged view of a tip of a microfluidic device according to an optional embodiment,

FIG. 3A shows an enlarged view of a tip of a microfluidic device according to a further optional embodiment, and

FIG. 3B shows an enlarged view of a tip of a microfluidic device according to a further optional embodiment;

FIG. 4 schematically illustrates a simulation of a hydrodynamic flow confinement, and

FIG. 5 schematically illustrates a method for providing a fluid in a hydrodynamic flow confinement.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

The microfluidic device may be adapted such that microfluidic effects are used by the device. At least some fluid guiding channels of the microfluidic device may be adapted such that physical and/or chemical properties of the fluid at a microscale can be exploited. The microfluidic devices may be adapted as a microfluidic pipette and optionally as a capillary-like micropipette. The tip of the microfluidic device may be provided in such a manner that the microfluidic device may be suitable for a use as a microfluidic pipette. The tip may have an opening at the end of the tip. The opening may be referred to as “aperture”. The terms “opening” and “aperture” of the tips may be used as synonyms. The microfluidic device may be adapted as a microfluidic pipette. The microfluidic device may be formed in one piece, wherein the tip and/or the microfluidic device itself are integrated as a single unit.

Hydrodynamic flow confinement may refer to a technique or process in fluid dynamics where a fluid's flow is restricted or directed in a controlled manner, often using physical barriers, forces, or fields. This confinement may be used to guide the fluid along a desired path, create specific flow patterns, or control the interaction of the fluid with surfaces or other fluids. The microfluidic device may be adapted such that the hydrodynamic flow confinement provided at the opening of the tip provides an envelope of jetting fluid of fixed spatial extent with a composition unique and distinct from the surrounding fluidic environment. Sheathed hydrodynamic flow confinement may refer to a technique or process in which hydrodynamic flow confinement is generated within an encompassing fluidic jet within the fluidic operating environment. This jet may be used to guide environmental fluid away from the device front end where hydrodynamic flow confinement is established. The encompassing fluidic jet may be provided with the same or a different fluid than the fluid for providing the hydrodynamic flow confinement. The front end and the back end may relate to different sections of the microfluidic device. However, the front end and the back end may relate to different sections of a single-pieced microfluidic device.

The first inflow channel extending outside (i.e. at an outer side, such as a radial outer side) of the outflow channel at the back end may be understood such that the inflow channel is separated from the outflow channel. The inflow channel and the outflow channel may be arranged adjacent to each other. The inflow channels and the outflow channel may be attached to each other or may be arranged with a spatial separation from each other. The inflow channel may be a reagent channel for holding and/or steering and/or introducing the fluid as a reagent to a target. The outflow channel may be a waste channel for removing used fluid after the HFC.

The outflow channel extending outside, i.e. at an outer side, such as a radial outer side, of the second inflow channel at the back end may be understood such that the second inflow channel is separated from the outflow channel. The second inflow channel and the outflow channel may be arranged adjacent to each other. The second inflow channels and the outflow channel may be attached to each other or may be arranged with a spatial separation from each other. The second inflow channel may be a reagent channel for holding and/or steering and/or introducing the fluid as a reagent to a target. The outflow channel may be a waste channel for removing used fluid after the HFC.

The first inflow channel and the second inflow channel may be used to provide the same or different fluids at the tip of the aperture.

The microfluidic device provides the advantage that it allows for providing a flow confinement of one fluid (containing chemical agents) through the first inflow channel within another fluid (a surrounding fluid medium) through the second inflow channel, optionally for the purpose of a delivery of chemical agents to cells. In other words, the disclosure may provide the advantage of providing a sheathed hydrodynamic flow confinement in which hydrodynamic flow confinement is generated by fluid provided through the first inflow channel within an encompassing fluidic jet provided through the second inflow channel within the fluidic operating environment. This jet may be used to guide environmental fluid away from the device's front end where hydrodynamic flow confinement is established.

Moreover, the disclosure provides the advantage of allowing a generation of a spatially confined fluid by hydrodynamic flow confinement.

Moreover, the disclosure provides the advantage that it allows for providing a device to protect the confined fluid flow against particulate disturbances (i.e. cellular debris) in the surrounding fluid.

The disclosure may further provide the advantage that a microfluidic device for achieving HFC can be provided with a small spatial footprint, which may render the microfluidic device suitable for applications on a microscopic scale, such as for providing a fluid in a controlled manner to a microscopic target, such as a (biological) cell.

Moreover, the disclosure provides the advantage that the first inflow channel, second inflow channel and outflow channel can be provided in a suitable manner to provide HFC on a microscopic scale at the tip of the microfluidic device, with HFC robust against clogging-induced disruption and yet allowing a convenient and separate connection to the outflow channel and the inflow channels at the backend of the microfluidic device. This may facilitate the connection of the inflow channels and the outflow channel of the microfluidic device with supply tubing at the back end and, as the inflow channel and the outflow channel extend outside of each other i.e. not one channel inside the other channel, at the back end.

Moreover, the disclosure provides the advantage that the microfluidic devices may exhibit desirable characteristics similar to glass pipettes, such as a small spatial footprint, axially symmetric profiles and performance and/or may facilitate an integration in and/or a use with a microscope.

The first inflow channel, the outflow channel, and optionally the second inflow channel, may meet at the tip at the front end. The first inflow channel, the outflow channel, and the second outflow channel may extend in a parallel and/or concentric manner to the tip at the front end.

This may facilitate the generation of a sheathed HFC at the opening at the tip of the microfluidic device.

The first inflow channel and/or the outflow channel and/or the second inflow channel may have a circular or elliptical cross-sectional shape. This may facilitate the manufacturing and/or the sanitation of the microfluidic device. The first inflow channel and/or the outflow channel and/or the second inflow channel may be continuous channels having a changing cross-sectional size and/or shape. The first inflow channel and/or the outflow channel and/or the second inflow channel may change their cross-sectional size from millimeter dimensions to micrometer dimensions at the aperture. The first inflow channel and the outflow channel and the second inflow channel may differ in the cross-sectional shape or share the same cross-sectional shape. The cross-sectional size of the first inflow channel may be smaller than the cross-sectional size of the outflow channel, which may facilitate arranging the inflow channel inside the outflow channel. The cross-sectional size of the outflow channel may be smaller than the cross-sectional size of the second inflow channel, which may facilitate arranging the outflow channel inside the second inflow channel.

The microfluidic device may include a first inflow channel wall forming the first inflow channel, an outflow channel wall forming the outflow channel, and a second inflow channel wall forming the second inflow channel. The first inflow channel wall, the second inflow channel wall and the outflow channel wall may flush at the aperture of the first inflow channel, the aperture of the outflow channel, and the aperture of the second inflow channel. Alternatively, the first inflow channel wall may protrude from the aperture of the outflow channel. Alternatively, the inflow channel walls may recede from the aperture of outflow channel. These configurations may facilitate the formation of a HFC at the opening of the tip.

The first inflow channel wall and/or the outflow channel wall and/or the second inflow channel wall may extend straight in a forward direction to the aperture at the tip or they may be at least partially angled with respect to the forward direction at the aperture. The apertures may all, or in part, lie in range from 0 to 90° to the longitudinal axis of the channel's inflow/outflow channels.

The cross-sectional shape of the tip of the microfluidic device may taper in a forward direction. Alternatively or additionally, the tip may have a length in a range from 1 mm to 50 mm and optionally from 2 mm to 10 mm. This may provide an advantageous spatial footprint of the microfluidic device for its use as a microfluidic pipette and/or for providing the fluid in a controlled manner to a microscopic target, such as a single cell.

A ratio between a diameter of the outflow channel and a diameter of the first inflow channel at the tip of the device may be in a range from 1.5 to 2.5. Alternatively or additionally, a ratio between a diameter of the second inflow channel and a diameter of the first inflow channel in a range from 2.5 to 4.5. The microfluidic device may have a diameter of the first inflow channel at the tip in a range from 1 μm to 5 μm. This may allow providing the inflowing and the outflowing fluid in a ratio suitable for a sheathed HFC.

The microfluidic device may further comprise a back end. At the back end, the first inflow channel may extend outside of the outflow channel and the outflow channel may extend outside of the second inflow channel. This may allow for the facilitation of a connection of the microfluidic device to supply fluids to the first inflow channel and the second inflow channel and to extract fluid from the outflow channel. The microfluidic device may further comprise a first inflow connector, an outflow connector, and a second inflow connector. These connectors may be arranged in the back end of the device. The microfluidic device may be adapted to allow connecting a first inflow supply tubing to the first inflow connector, an outflow supply tubing to the outflow connector, and a second inflow supply tubing to the second inflow connector in a separate manner.

Accordingly, the microfluidic device may further comprise a central section arranged between the front end and the back end. The first inflow channel may penetrate an outflow channel wall of the outflow channel in the central section. Optionally, the outflow channel may penetrate the second inflow channel in the central section. This may allow providing the microfluidic device in an integrated manner having a small spatial footprint.

The microfluidic device may operate by a fluid, such as a reagent solution, being introduced within the inflow channel being a reagent channel. Optionally the reagent fluid is also introduced and held within the microfluidic device, and pressurized air may be applied to induce fluid flow. Positive pressure may be applied to the reagent channel while simultaneously negative pressure may be applied to the outflow channel being a waste channel. Fluidic flow out of the reagent channel may be steered into the waste channel, within a confined volume bounded by the open fluidic environment in which the device tip is immersed. Fluid flow may be actuated by an application of pressurized air which communicates with the fluid (reagent solution, or sample medium). This mode of operation may correspond to ‘pressure-driven flow’ in microfluidics.

Pressure applied to the inflow channels at the backend may encompass the range 1-1,000 mbar, and pressure applied to the outlet channel at the backend may also encompass the range 1-1,000 mbar. Fluid injected out of the tip outlet apertures may encompass the range 0.01-100 nL/s and fluid aspirated into the inlet aperture of the tip may encompass the range 0.01-100 nL/s. The volume of material injected out of the outlet aperture at the tip that is said to be hydrodynamically confined in the open fluidic medium may have a volume in the range from 1 to 2.500 fl. The velocities of fluid contributing to the hydrodynamic flow confinement envelope may encompass the range 1-100 mm/s.

The microfluidic device may be regarded as a capillary micropipette-like device. This classification may also serve to conceptually distinguish the specific design elements of the disclosure from existing prior art wherein HFC is generated from larger scanning probe and scanning-head devices.

Three optional design features of a microfluidic device according to the disclosure are detailed below, with their advantages summarized and without limiting the disclosure to said optional design features.

1. Incorporated pneumatic fixtures onto a capillary micropipette channel:

The microfluidic device may feature a structure at the end of each channel whose structure is specifically designed for the purpose of connecting to pneumatic tubing. This portion of the channel may be referred to as the pneumatic-fixture portion. The pneumatic-fixture portion may have a structure distinct from the remainder of the channel (where the channel performs different functions). The structure of the pneumatic-fixture may embody different forms of pneumatic connectors, for example: a smooth-bore plug, such as a Luer-type connector, or a threaded connector and/or a screw-type connector. This feature may enable the device to be disconnected from the pneumatic pressure source in a way that can be reconnected repeatedly and readily with little effort.

Conventional micropipettes pulled from a multi-channel capillary feature a constant geometrical cross-section designed for the transport of fluid along the channel length or preference for aperture arrangement, but not for the connection of pneumatic tubes to the channel. Examples may include so-called “Theta”-capillaries or “double-barrel”-capillaries. To connect pneumatic tubing separately to each internal channel in a way that ensures no leaking or cross-talk is not possible with conventional micropipettes. In practice, this problem may conventionally be solved by glueing the pneumatic tubing onto and/or into a glass capillary to fix and seal the connection once. This introduces numerous operational challenges and difficulties and, thus, involves a significant effort.

2. Fluidic channels structured differently along their length to perform different functions:

Arrangement of the three channels can be changed along the length of the microfluidic device, such as a concentric arrangement of the inflow channel and the outflow channel at the tip portion, and a side-by-side arrangement at a reservoir and pneumatic-fixture portion, which may be in the back end of the microfluidic device. This aspect of the design may grant the device an advantageous feature-set for its utility that is not available for existing devices in the prior art.

3. Microfluidic device having small physical dimensions:

The apertures at the tip portion, arranged concentrically, may have dimensions within a range of 1-20 μm, and optionally in a range of 1-10 μm. For example, the three concentrically arranged apertures may have diameters of 5, 10 and 15 μm. This may be advantageous for utilizing the microfluidic device for creating sheathed-HFC, with an HFC zone having a size in the order of a typical biological cell or smaller.

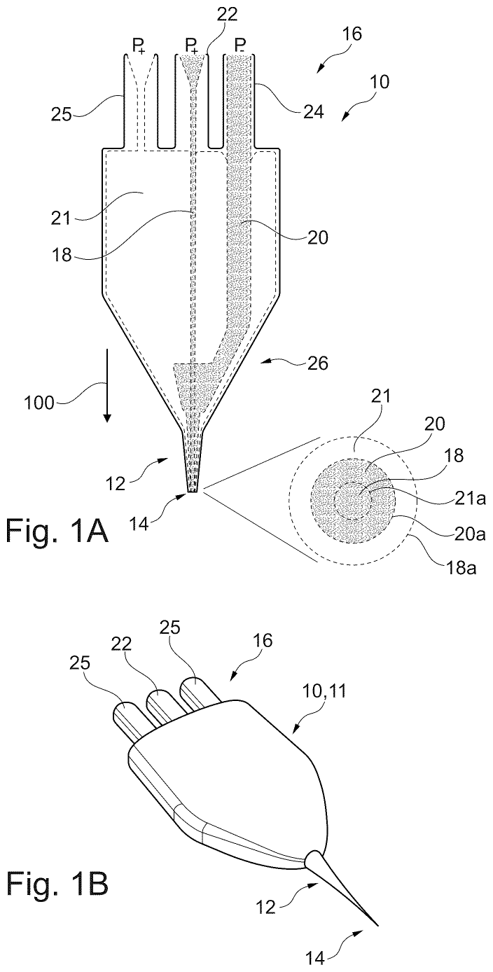

FIG. 1A illustrates a microfluidic device 10 according to an optional embodiment. The microfluidic device 10 has a front end 12 that includes a tip 14 with an opening for providing a hydrodynamic flow confinement 30. The device comprises a first inflow channel 18 adapted to provide a microfluidic flow to the tip 14, an outflow channel 20 adapted to collect at least partially the microfluidic flow provided via the first inflow channel 18 at the tip 14, and a second inflow channel 21 adapted to provide a microfluidic flow to the tip 14. At the front end 12, the first inflow channel 18 extends within the outflow channel 20 and the outflow channel 20 extends within the second inflow channel 21.

Optionally, at the front end 12, the first inflow channel 18 and the outflow channel 20 and the second inflow channel 21 may meet at the tip 14. The first inflow channel 18, the outflow channel 20 and the second outflow channel 20 may extend in a parallel manner and/or in a concentric manner to the tip 14. The first inflow channel 18, the outflow channel 20 and the second inflow channel 21 may have a circular or elliptical cross-sectional shape, as can be seen in the enlarged section in the lower right corner of FIG. 1A.

A first inflow channel wall 18a forming the first inflow channel 18, an outflow channel wall 20a forming the outflow channel 20, and a second inflow channel wall 21a forming the second inflow channel 20 flush at the aperture of the first inflow channel 18 and the aperture of the outflow channel 20 and the aperture of the second inflow channel 21. Alternatively, the first inflow channel wall 18a may protrude from the aperture of the outflow channel 20.

The first inflow channel wall 18a and/or the outflow channel wall 20a and/or the second inflow channel wall 21a may extend straight in a forward direction 100 to the aperture at the tip 14 or may be at least partially angled with respect to the forward direction 100 at the aperture.

The cross-sectional shape of the tip 14 of the microfluidic device 10 may taper in a forward direction 100. The tip 14 may have a length in a range from 1 mm to 50 mm and optionally from 2 mm to 10 mm.

The microfluidic device 10 further comprises a back end 16, wherein at the back end 16 the first inflow channel 18 extends outside of the outflow channel 20 and the outflow channel 20 extends outside of the second inflow channel 21. The microfluidic device 10 may further comprise a first inflow connector 22, an outflow connector 24 and a second inflow connector 25, wherein the first inflow connector 22 and the outflow connector 24 and the second inflow connector 25 are arranged in the back end 16. The pressure indicators P₊ and P₋ indicate the respective pressure to be applied to the first inflow connector 22, the second inflow connector 25 and the outflow connector 24. P+ indicates a pressure to push the fluid in the forward direction towards the tip 14, wherein P₋ indicates a pressure to suck the fluid against the forward direction through the tip 14.

The first inflow connector 22, the outflow connector 24, and the second inflow connector 25 may be adapted to allow connecting a first inflow supply tubing to the first inflow connector 22, an outflow supply tubing to the outflow connector 24, and a second inflow supply tubing to the second inflow connector 25 in a separate manner. The connectors 22, 24, 25 being provided in a separate manner facilitates the connection.

The microfluidic device 10 further comprises a central section 26 arranged between the front end 12 and the back end 16, wherein the first inflow channel 18 penetrates the outflow channel 20 wall of the outflow channel 20 in the central section 26. This allows for having a concentric configuration of the first inflow channel 18 and the outflow channel at the front end 12 and a separate configuration at the back end 16.

FIG. 1B illustrates a microfluidic device 10 according to an optional embodiment in a perspective view. The microfluidic device 10 is adapted as a microfluidic pipette 11. The microfluidic device 10 is formed as one single piece.

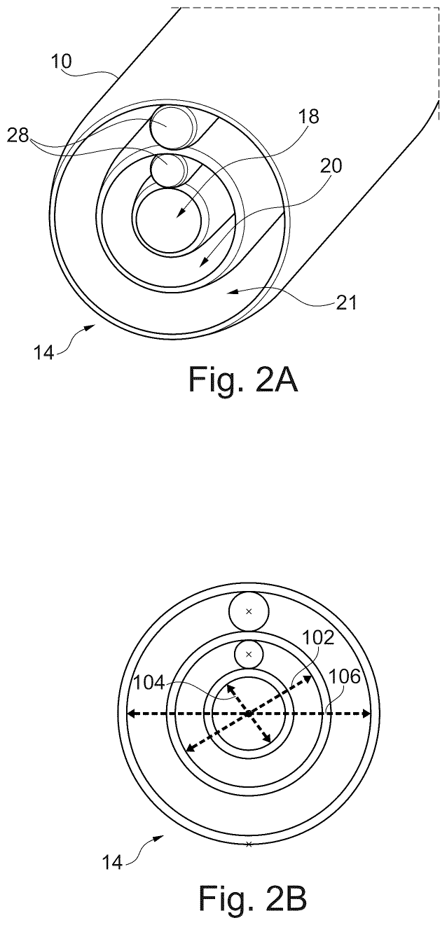

FIG. 2A illustrates an enlarged view of a tip 14 of a microfluidic device 10 according to an optional embodiment. According to the presented embodiment, the first inflow channel 18, the outflow channel 20 and the second inflow channel are arranged in a concentric manner. The microfluidic device may comprise stabilizers 28 to mechanically stabilize the relative arrangement of the first inflow channel 18, the outflow channel 20 and the second inflow channel 21 with respect to each other. The stabilizers may extend parallel to the first inflow channel 18, the outflow channel 20 and the second inflow channel 21. The diameter 104 of the first inflow channel 18 may be in a range of 1 μm to 10 μm.

FIG. 2B illustrates optional dimensions in micrometers of a tip 14 of a microfluidic device according to an optional embodiment. This figure provides an enlarged view of the tip 14 of the microfluidic device 10. In this embodiment, at the tip 14 of the microfluidic device 10, the diameter 104 of the first inflow channel 18 is 9 μm, the diameter 102 of the outflow channel 18 is 18 μm, and the diameter 106 of the second inflow channel 18 is 30 μm. The first inflow channel wall 18a, the outflow channel wall 20a and the second inflow channel wall have a thickness of 1 μm each.

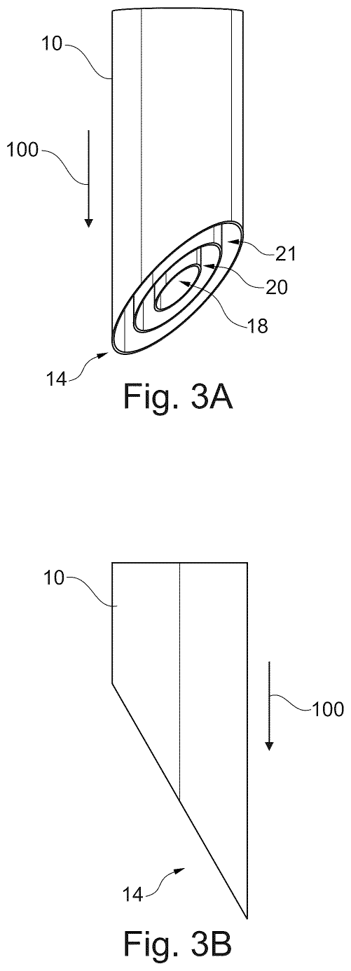

FIG. 3A illustrates a microfluidic device 10 according to an optional embodiment. The figure provides an enlarged view of a tip 14 of the microfluidic device 10. In this embodiment, the first inflow channel wall 18a and/or the outflow channel wall 20a and/or the second inflow channel wall 21a are angled with respect to the forward direction 100 at an angle of about 45° at the aperture 14.

FIG. 3B illustrates a microfluidic device 10 according to a further optional embodiment. In this embodiment, the first inflow channel wall 18a and/or the outflow channel wall 20a and/or the second inflow channel wall 21a are angled with respect to the forward direction 100 at an angle of about 45° at the aperture of the tip 14.

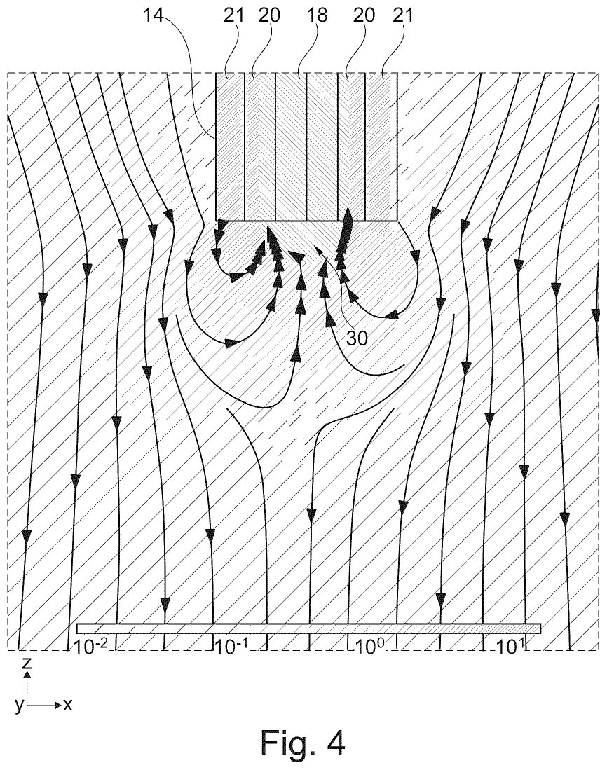

FIG. 4 schematically illustrates a simulation of a hydrodynamic flow confinement 30 provided at a tip 14 of a microfluidic device 10 according to an optional embodiment. The grayscale indicates the fluid speed in mm/s. FIG. 4 depicts a cross-sectional view through the tip 14. The hydrodynamic flow confinement 30 zone is built up right at the aperture of the first inflow channel 18. At least a part of the fluid exiting the tip 14 via the first inflow channel 18 is sucked into the outflow channel 20. A sheath protecting the HFC 30 zone is provided via a fluid exiting the second inflow channel 21 surrounding the HFC 30 zone.

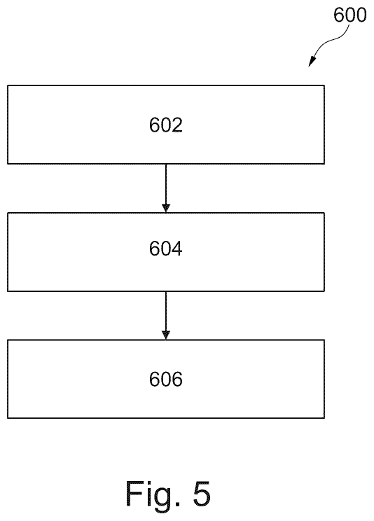

FIG. 5 schematically depicts a method 600 according to an optional embodiment for providing a fluid in a hydrodynamic flow confinement 30.

The method 600 comprises providing 602 a microfluidic device 10 having a front end 12 comprising a tip 14 with an opening for providing the sheathed hydrodynamic flow confinement 30, wherein at the front end 12 a first inflow channel 18 extends within an outflow channel 20 and the outflow channel 20 extends within a second inflow channel 21.

The method 600 further comprises providing 604 a microfluidic flow of the fluid to the tip 14 via the first inflow channels 18 of the microfluidic device 10.

The method further comprises at least partially collecting 606 the microfluidic flow of the fluid provided via the first inflow channel 18 and the second inflow channel 21 at the tip 14 by the outflow channel 20 of the microfluidic device 10.

### REFERENCE SYMBOLS

10 microfluidic device
11 microfluidic pipette
12 front end
14 tip
16 back end
18 first inflow channel
18a first inflow channel wall
20 outflow channel
20a outflow channel wall
21 second inflow channel
21a second inflow channel wall
22 first inflow connector
24 outflow connector
25 second inflow connector
26 central section
28 stabilizer
30 hydrodynamic flow confinement
100 forward direction
102 diameter of the outflow channel
104 diameter of the first inflow channel
106 diameter of the second inflow channel
600 method for providing a fluid in a hydrodynamic flow confinement
602-606 method steps

What is claimed is:

1. A microfluidic device, comprising:
a front end including a tip with an opening for providing a sheathed hydrodynamic flow confinement;
a first inflow channel adapted to provide a microfluidic flow to the tip;
an outflow channel adapted to collect at least partially the microfluidic flow provided via the first inflow channel at the tip; and
a second inflow channel adapted to provide a microfluidic flow to the tip;
wherein at the front end the first inflow channel extends within the outflow channel and the outflow channel extends within the second inflow channel.

2. The microfluidic device according to claim 1, wherein at the front end the first inflow channel and the outflow channel meet at the tip.

3. The microfluidic device according to claim 1, wherein at the front end the first inflow channel, the outflow channel and the second outflow channel extend in at least one of a parallel manner and a concentric manner to the tip.

4. The microfluidic device according to claim 1, wherein at least one of the first inflow channel, the outflow channel, and the second inflow channel have a circular or elliptical cross-sectional shape.

5. The microfluidic device according to claim 1, wherein a first inflow channel wall forming the first inflow channel and an outflow channel wall forming the outflow channel and a second inflow channel wall forming the second inflow channel flush at an aperture of the first inflow channel and an aperture of the outflow channel and an aperture of the second inflow channel, or wherein the first inflow channel wall protrudes from the aperture of the outflow channel.

6. The microfluidic device according to claim 1, wherein at least one of a first inflow channel wall, an outflow channel wall, and a second inflow channel wall extend straight in a forward direction to an aperture at the tip or is at least partially angled with respect to the forward direction at the aperture.

7. The microfluidic device according to claim 1, wherein a cross-sectional shape of the tip of the microfluidic device tapers in a forward direction.

8. The microfluidic device according to claim 1, wherein the tip has a length in a range from 1 mm to 50 mm.

9. The microfluidic device according claim 1, wherein at the tip of the microfluidic device at least one of a ratio between a diameter of the outflow channel and a diameter of the first inflow channel is in a range from 1.5 to 2.5 and wherein a ratio between a diameter of the second inflow channel and the diameter of the first inflow channel is in a range from 2.5 to 4.5.

10. The microfluidic device according to claim 1, wherein at the tip of the microfluidic device a diameter of the first inflow channel is in a range from 1 μm to 5 μm.

11. The microfluidic device according to claim 1, wherein the microfluidic device further comprises a back end, wherein at the back end the first inflow channel extends outside of the outflow channel and the outflow channel extends outside of the second inflow channel.

12. The microfluidic device according to claim 11, further comprising a first inflow connector, an outflow connector, and a second inflow connector, wherein the first inflow connector, the outflow connector and the second inflow connector are arranged in the back end.

13. The microfluidic device according to claim 12, wherein the first inflow connector, the outflow connector, and the second inflow connector are adapted to allow connecting a first inflow supply tubing to the first inflow connector, an outflow supply tubing to the outflow connector, and a second inflow supply tubing to the second inflow connector in a separate manner.

14. The microfluidic device according to claim 11, further comprising a central section arranged between the front end and the back end, wherein the first inflow channel penetrates an outflow channel wall of the outflow channel in the central section.

15. The microfluidic device according to claim 1, wherein the microfluidic device is a microfluidic pipette.

16. The microfluidic device according to claim 1, wherein at least one of the tip and the microfluidic device are formed in one piece.

17. A method for providing a fluid in a sheathed hydrodynamic flow confinement, the method comprising:
providing a microfluidic device having a front end comprising a tip with an opening for providing the sheathed hydrodynamic flow confinement, wherein at the front end a first inflow channel extends within an outflow channel and the outflow channel extends within a second inflow channel;
providing a microfluidic flow of the fluid to the tip via the first inflow channels of the microfluidic device;
at least partially collecting the microfluidic flow of the fluid provided via the first inflow channel and the second inflow channel at the tip by the outflow channel of the microfluidic device.
